(19) United States
(12) Patent Application Publication
(10) Pub. No.: US 2018/0264923 A1
(43) Pub. Date: Sep. 20, 2018

(54) POWER TRAIN FOR DRIVING A MOTOR VEHICLE WITH A VARIABLE-SPEED TRANSMISSION DEVICE HAVING A DOUBLE PLANETARY GEAR SET AND ESPECIALLY A POWER TRAIN FOR HYBRID-TYPE VEHICLE

(71) Applicant: IFP Energies nouvelles, Rueil-Malmaison Cedex (FR)

(72) Inventor: Stephane VENTURI, ROIFFIEUX (FR)

(21) Appl. No.: 15/534,894

(22) PCT Filed: Dec. 1, 2015
(86) PCT No.: PCT/EP2015/078193

§ 371 Date: Jun. 9, 2017

(30) Foreign Application Priority Data
Dec. 12, 2014 (FR) 14 62324

(51) Int. Cl. B60K 6/365; B60K 6/387; B60K 6/383

(52) U.S. Cl. CPC B60K 6/365; F16H 3/663; B60K 6/383; B60K 6/387

(57) ABSTRACT

The present is a powertrain for an automotive vehicle comprising a thermal engine (10), a speed variation device (14) including an engine epicyclic gear train (26) with a sun gear (36) and a crown (50), each connected to shaft (12) of thermal engine (10) by a controlled clutch (28, 30, 30′) and to a fixed part (46) of the vehicle by a one-way coupling (32, 34). A machine epicyclic gear train (90) is arranged on a machine shaft (92) which is substantially parallel to engine shaft (12) and connecting engine epicyclic gear train (26) to a track (126, 128) for motion transmission to a drive axle (16). The machine epicyclic gear train comprises a sun gear (104) carried by a sun gear shaft (110), a crown (112) and a planet gear carrier (94). Speed variation device (14) comprises an engine toothed wheel (150) carried by engine shaft (12) which connects the shaft to a machine toothed wheel (152, 176) carried by sun gear shaft (110).

### CROSS REFERENCE TO RELATED APPLICATIONS

Reference is mode to International Application No. PCT/EP2015/078193 filed Dec. 1, 2015, and French Application No. 14/62.324 filed Dec. 12, 2014, which are incorporated herein by reference in their entirety.

### BACKGROUND OF THE INVENTION

### Field of the Invention

The present invention relates to a powertrain for an automotive vehicle with a variable-speed transmission device comprising a double epicyclic gear train which is in particular a powertrain for a hybrid type vehicle.

### Description of the Prior Art

As it is already known, the above type of vehicle comprises a powertrain that uses, alone or in combination, as a traction/propulsion drive means, a thermal engine, generally of internal-combustion type, with a speed variation device and a driving/receiving machine, like a rotary electrical machine connected to an electrical source, such as one or more electrical accumulators or batteries.

This combination allows optimizing the performance of this vehicle, by reducing the discharge of emissions to the atmosphere as well as the fuel consumption.

Thus, when the vehicle is to be driven with a high torque over a wide speed range while limiting exhaust gas and noise generation, as in an urban site, the electrical machine is preferably used for driving the vehicle.

On the other hand, the thermal engine is used for driving the vehicle for uses where a high driving power and a wide operating range are required.

As is already known from French patent application No. 2,955,165 filed by the applicant, the automotive vehicle powertrain comprises a thermal engine with a shaft connected to a variable-speed transmission device including an engine epicyclic gear train with a sun gear and a crown connected each to the thermal engine shaft by a controlled coupling and to a fixed part of the powertrain by a one-way automatic coupling, and a planet gear carrier transmitting the speed variation to the drive axle of the vehicle through a transmission track comprising the elements contained between the planet carrier shaft and the axle, which provide kinematic connection between this shaft and this axle.

In order to increase the speed variation capacity when the vehicle is driven by the electrical machine, the applicant has combined the variable-speed transmission device of the aforementioned document with another epicyclic gear train connecting the engine epicyclic gear train to a track for motion transmission to the drive axle of the vehicle, as described in French patent application No. 2,962,697 filed by the applicant. In this configuration, the transmission track also comprises all the elements contained between the planet carrier shaft of the other epicyclic gear train and the axle.

Although it performs adequately, the applicant has further improved this speed variation device by making it possible to increase the number of gear ratios with a variable-speed transmission device of simple and inexpensive design.

### SUMMARY OF THE INVENTION

The invention therefore relates to a powertrain for an automotive vehicle comprising a thermal engine, a speed variation device including an engine epicyclic gear train with a sun gear and a crown which are each connected to the thermal engine shaft by a controlled coupling and to a fixed part of the vehicle by a one-way coupling. A machine epicyclic gear train is arranged on a machine shaft substantially parallel to the engine shaft and connects the engine epicyclic gear train to a track for motion transmission to a drive axle. The machine epicyclic gear train comprises a sun gear carried by a sun gear shaft, a crown and a planet gear carrier. The speed variation device comprises an engine toothed wheel carried by the engine shaft which connects the shaft to a machine toothed wheel carried by the sun gear shaft.

The engine toothed wheel can be mounted idle on the engine shaft and the shaft can carry a controlled coupling for connection between the shaft and the wheel.

The controlled coupling can comprise a disc clutch.

The engine toothed wheel can be fixedly mounted on the engine shaft.

The machine toothed wheel can be fixedly mounted on the sun gear shaft.

The machine toothed wheel can be mounted idle on the sun gear shaft and the shaft can carry a controlled coupling for connection between the shaft and the wheel.

The controlled coupling can cooperate with a bearing surface carried by the machine toothed wheel or with a bearing surface carried by a sleeve mounted to idle on the sun gear shaft.

The sleeve can be carried by a fixed part of the powertrain through a one-way coupling.

The sun gear shaft can carry a controlled coupling for connection with the sleeve.

The controlled coupling can cooperate with a bearing surface carried by the machine toothed wheel or with a bearing surface carried by a fixed part of the powertrain.

The powertrain can comprise a driving and generator machine for imparting at least motion to the vehicle.

The rotor of the machine can be connected to the sun gear shaft.

### BRIEF DESCRIPTION OF THE FIGURES

Other features and advantages of the invention will be clear from reading the description hereafter, given by way of non limitative example, with reference to the accompanying figures wherein:

FIG. 1 is a diagram of a powertrain according to the invention applied to a hybrid vehicle;

FIG. 2 diagrammatically illustrates a variant of the powertrain of FIG. 1; and

FIG. 3 shows a variant of the powertrain of FIG. 2,

### DETAILED DESCRIPTION OF THE INVENTION

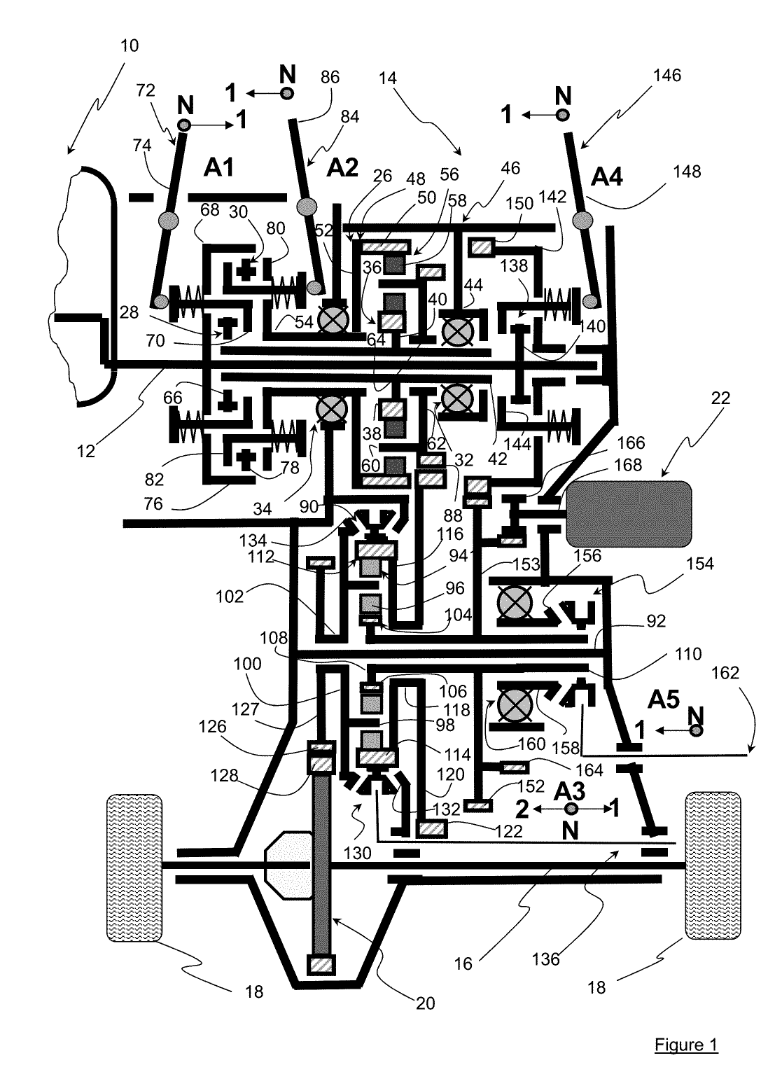

In FIG. 1, the powertrain comprises a thermal engine 10, notably an internal-combustion engine, with an engine shaft 12, coming from the crankshaft of the engine, a speed variation device 14 and a drive axle 16 allowing to drive driving wheels 18 of the vehicle, advantageously through the agency of a differential bridge 20.

Within the context of the use of this powertrain for a hybrid vehicle, a driving/receiving machine 22 is associated therewith.

In the example below, the driving and receiving machine is an electrical machine that is used either as an electrical motor for driving the vehicle wheels or as a receiving machine for generating a source of electrical current, notably for recharging the batteries.

Of course, any other type of driving and receiving machine, such as a hydraulic or pneumatic machine, can be used.

Speed variation device 14 comprises a main epicyclic gear train 26, which is referred to as thermal engine epicyclic gear train, with two controlled couplings 28 and 30 in the form of disc clutches, and two one-way automatic couplings, such as free wheels 32 and 34.

More precisely, engine epicyclic gear train 26 comprises a sun gear 36 with an externally toothed wheel 38 carried by a flange 40. This flange is fixedly mounted on a tubular shaft 42, referred to as sun gear shaft, which tops engine shaft 12 while being free in rotation but fixed in translation with respect thereto. This shaft rests against a bearing 44 carried by a fixed part 46 of the vehicle powertrain, such as the housing of this powertrain, through one-way coupling 32, referred to as sun gear free wheel.

This gear train also comprises a crown 48 with an internally toothed wheel 50 arranged concentrically to the sun gear and a connecting web 52 linked to a tubular shaft 54, which is referred to as crown shaft, that surrounds the sun gear tubular shaft 42 while being free to rotate, but fixed to not translate with respect to the tubular shaft. This crown is externally connected to fixed part 46 of the vehicle powertrain by one-way coupling 34, which is referred to as crown tree wheel.

Of course, the two free wheels 32 and 34 are arranged so that crown 48 and sun gear 36 con rotate only in the same direction, and preferably in the same direction as engine shaft 12.

Finally, the engine epicyclic gear train comprises a planet gear carrier 56 with advantageously has three planet gears 58 in form of externally toothed wheels, arranged at the same angular interval with respect to one another (120° here) and meshing with the crown and the sun gear.

Crown ring 50, sun gear wheel 38 and planet gears 58 are therefore arranged in the same plane, which here is a vertical plane relative to FIG. 1.

The planet gears are each carried by a horizontal pin 60 which is free to rotate, but is fixed not to translate thereon. The planet gear pins are connected to a vertical wall 62 linked to a tubular shaft 64, which is referred to as planet gear carrier shaft, that surrounds sun gear shaft 42 while rotating freely thereon.

The free ends of the sun gear and crown shafts each carry a controlled coupling 28 and 30, which preferably is a friction disc clutch.

Thus, clutch 28, referred to as sun gear clutch, comprises a friction disc 66, fixed in rotation but free in axial translation on sun gear shaft 42. This friction disc is intended to be clamped between a reaction plate 68 mounted fixedly in translation and in rotation on engine shaft 12 and a pressure plate 70, mobile in translation with respect to this pressure plate while being fixed in rotation therewith. The axial motion of this pressure plate is controlled by a clutch actuator 72 (actuator A1), which here is in the form of a lever 74 pivoting on a fixed point of the powertrain, between a clutch disengaged position (position N) and a clutch engaged position (position 1).

Pressure plate 68 is extended, on the external periphery thereof, by a horizontal wall 76 that carries, fixed in rotation and free in axial translation, another friction disc 78, which is coaxial with friction disc 66 and belongs to the other clutch 30, referred to as crown clutch.

This disc is clamped between a reaction plate 80, mounted fixedly to not translate and to rotate on the free end of crown shaft 54, and a pressure plate 82 mobile in axial translation through the action of another clutch actuator 84 (actuator A2). As mentioned above, this actuator is a lever 86 pivoting on a fixed point of the powertrain between a clutch disengaged position (position N) and a clutch engaged position (position 1).

As is better illustrated in FIG. 1, vertical wall 62 of planet gear carrier 56 includes an externally toothed horizontal wheel 88 whose purpose is explained in the description below.

As is more visible in FIG. 1, the speed variation device comprises another epicyclic gear train 90, which is referred to as machine epicyclic gear train.

This machine epicyclic gear train 90 is mounted on a shaft 92, which is referred to as machine shaft, that is substantially parallel to shaft 12 and is fixedly carried by fixed port 46 of the powertrain.

This gear train comprises a planet gear carrier 94 which advantageously has three planet gears 96, in the form of externally toothed wheels, which are arranged on planet gear pins 98 carried by a web 100 that is carried by a tubular shaft 102 surrounding shaft 92 and is arranged in the some angular interval with respect to one another (120° here).

These planet gears cooperate by meshing with a sun gear 104 comprising an externally toothed wheel 106 carried by a flange 108. Flanging is fixedly mounted on a tubular shaft 110, which is referred to as additional sun gear shaft, surrounds machine shaft 92, while being in rotation but fixedly in translation. The planet gears also cooperate by meshing with a crown 112 which comprises an internally toothed wheel 114 carried by a web 116 connected to a tubular crown shaft 118. Shaft 118 surrounds sun gear shaft 110 and it further comprises a web 120 provided, at the end thereof, with an externally toothed wheel 122 that cooperates with wheel 88 carried by planet gear carrier 56 of engine epicyclic gear train 26.

Of course, like engine epicyclic gear train 26, wheel 114 of crown 112, sun gear wheel 106 and planet gears 96 are arranged in the same plane, which is here a vertical plane considering FIG. 1.

Tubular shaft 102 of the planet gear carrier also carries an externally toothed wheel 126 on the end of a web 127 that cooperates with a toothed wheel 128 linked to drive axle 16. This assembly of two toothed wheels forms a motion transmission track between machine epicyclic gear train 90 and axle 16.

Crown 112 of the epicyclic gear train 90 also carries a controlled coupling 130 (actuator A3), which here is in form of a double-acting synchromesh allowing connection of crown 112 either to web 100 of planet gear carrier 94 or to fixed part 46 of the powertrain.

By way of example only, this coupling comprises a synchromesh with two meshing positions (1 and 2) and one neutral position (N). The synchromesh is fixedly carried in rotation by the outer wall of wheel 14 of crown 112 while being free to translate thereon. The synchromesh cooperates with either a fixed coupling surface 132 carried by a fixed port 46 of the powertrain, or with another coupling surface 134 carried by the peripheral end of web 100 of planet gear carrier 94.

The synchromesh is therefore driven by a control 136 enabling achieving coupling with the fixed part of the powertrain (position 1), with the planet gear carrier (position 2), or to be in neutral position without connection with any of the two coupling surfaces.

Engine shaft 12 carries, in the end area opposite to the end carrying clutches 28 and 30, a controlled coupling 138, which here is in the form of a disc clutch.

The clutch comprises a friction disc 140 fixedly carried by engine shaft 12. The friction disc is intended to be clamped between a reaction plate 142, which is mounted to be free in rotation and to translate on engine shaft 12, and a pressure plate 144, free to translate with respect to the pressure plate while being fixed to rotate therewith. Axial motion of the pressure plate is controlled by a clutch actuator 146 (actuator A4), which is here in the form of a lever pivoted on a fixed point of the powertrain.

The reaction plate carries an outer engine toothed wheel 150 that cooperates with a machine toothed wheel 152 which is fixedly carried by a web 153 connected to tubular sun gear shaft 110.

Tubular sun gear shaft 110 carries, in the end area opposite to the end carrying machine epicyclic gear train 90, a controlled coupling 154 (actuator A5), which here is in the single-acting synchromesh.

The synchromesh is mounted fixed to rotate but free to translate on shaft 110 to cooperate with a bearing flank 156 carried by a tubular sleeve 158. This sleeve surrounds sun gear shaft 110 and is connected to fixed part 46 of the powertrain by a one-way coupling 160 such as a free wheel.

Thus, when synchromesh 154 and sleeve 158 mesh, the free wheel fulfils the same function as the first two. It is blocked on fixed part 46 when at least one of clutches 72 and 84 is in engaged position and clutch 146 is in disengaged position. This situation occurs for three of the seven gear ratios.

When synchromesh 154 and sleeve 158 mesh, the free wheel rotates either if the thermal engine is running and clutch 146 is in engaged position, or if electrical machine 22 is running so as to obtain a forward gear, or when these two situations occur simultaneously.

When synchromesh 154 and sleeve 158 do not mesh, it is possible to obtain the reverse gear. Machine 22 therefore needs to be controlled in the opposite direction of rotation.

When synchromesh 154 and sleeve 158 do not mesh, it is also possible to use the transmission as a power split transmission.

This synchromesh is driven by a control 162 enabling it to achieve coupling with flank 156 of sleeve 158 (position 1) or to be in neutral position without connection with any one of the coupling surfaces (position N).

Advantageously, the web of toothed wheel 152 carries an externally toothed wheel 164 that cooperates with a toothed wheel 166 carried by rotor 168 of machine 22.

The various gear ratio configurations are now detailed in the table below.

| | Actuator | | | | | Gear |
|---|---|---|---|---|---|---|
| | A1 | A2 | A4 | A3 | A5 | ratio |
| Position | N | N | N | N | N | 0 |
| | N | N | 1 | N/1 | N/1 | 1 |
| | 1 | N | N | N | 1 | 2 |
| | 1 | N | N | 2 | N/1 | 3 |
| | 1 | N | 1 | N | N/1 | 4 |
| | N | 1 | N | N | 1 | 5 |
| | N | 1 | N | 2 | N/1 | 6 |
| | N | 1 | 1 | N | N/1 | 7 |
| | 1 | 1 | N | N | 1 | 8 |
| | 1 | 1 | N | 2 | N/1 | 9 |
| | 1 | 1 | 1 | N | N/1 | 10 |

This allows 10 gear ratios to be obtained, including 3 with blocking of machine 22 by actuator A5 and free wheel 160 (ratios 2, 5 and 8).

Thus, when machine 22 is not blocked, for the 7 gear ratios 1, 3, 4, 6, 7, 9 and 10, the transmission con be used as a parallel hybrid transmission.

When the 3 gear ratios 2, 5 and 8 are used, the e-CVT mode (driven by machine 22) is available in each of these gear ratios by controlling the electrical machine in driving mode.

While one of these three gear ratios (2, 5 and 8) is used, if actuator A5 is in position N, the e-CVT mode is available in each of these gear ratios whatever the state of machine 22, whether in driving or receiving mode.

The pure electrical mode in the short gear ratio is obtained when A3 is in position 1, and A5 and A4 in neutral position. In this mode, the vehicle con be run in pure electrical mode in forward and in reverse gear.

If A5 is in position 1, only forward gear is available.

If A3 is in position N, reverse gear and energy recovery in forward gear are no longer accessible.

The pure electrical mode in the long gear ratio is obtained when A3 is in position 2. In this mode, the vehicle con be run in pure electrical mode in forward gear.

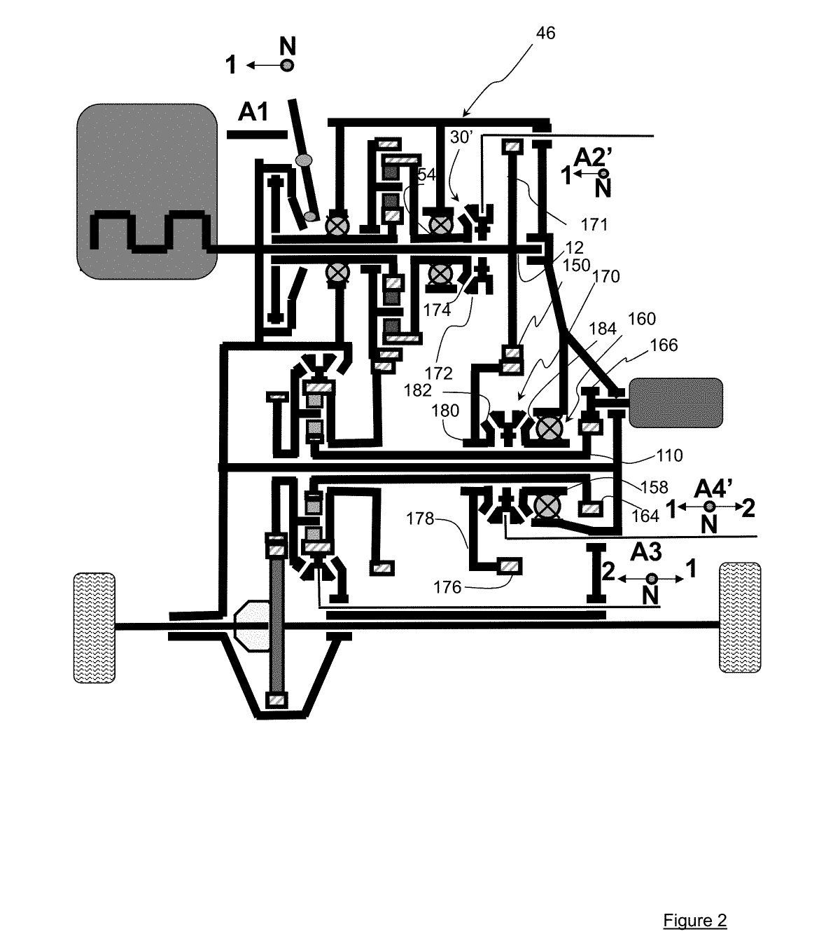

The variant of FIG. 2 differs from FIG. 1 in that clutch 138 of engine shaft 12 and its actuator A4 have been grouped together with actuator A5 so as to form a double-acting controlled coupling 170 (actuator A4′). Only engine toothed wheel 150 of FIG. 1 remains, which is mounted, in the case of FIG. 2, at the end of a web 171 fastened to engine shaft 12.

Furthermore, the coupling in form of a disc clutch 30 of crown 48, as shown in FIG. 1, has been replaced with a controlled coupling 30′ in form of a single-acting synchromesh 172 (actuator A2′). This synchromesh is fixed to rotate on engine shaft 12 but is movable in the axial translation under the action of a control for shifting from a neutral position (position N) to an active position (position 1) where the synchromesh is rotatingly connected to a linking face 174 carried by tubular crown shaft 54.

Wheel 150 cooperates with a toothed machine wheel 176 carried by a web 178 mounted on a tubular shaft 180 that surrounds tubular sun gear shaft 110.

Furthermore, sleeve 158 is, as in FIG. 1, connected to fixed part 46 of the powertrain by a one-way coupling 160 while surrounding tubular sun gear shaft 110.

As is more visible in FIG. 2, controlled coupling 170 is a double-acting synchromesh arranged on tubular sun gear shaft 110 while being fixed in rotation but free in translation. This synchromesh is arranged between tubular shaft 180 and sleeve 158, and cooperates in a neutral position (position N) with a bearing surface 184 carried by tubular shaft 158.

Furthermore, tubular sun gear shaft 110 carries a toothed wheel 164 that cooperates with toothed wheel 166 carried by the rotor of machine 22.

The operation of this variant, whether in electrical or thermal traction/propulsion mode, is identical to the one of FIG. 1, as shown in the table below.

Actuator

| | A1 | A2′ | A4′ | A3 | Gear ratio |
|---|---|---|---|---|---|
| Position | N | N | N | N | 0 |
| | N | N | 1 | N/1 | 1 |
| | 1 | N | 2 | N | 2 |
| | 1 | N | N | 2 | 3 |
| | 1 | N | 1 | N | 4 |
| | N | 1 | 2 | N | 5 |
| | N | 1 | N | 2 | 6 |
| | N | 1 | 1 | N | 7 |
| | 1 | 1 | 2 | N | 8 |
| | 1 | 1 | N | 2 | 9 |
| | 1 | 1 | 1 | N | 10 |

When machine 22 is not blocked, i.e. for the 7 gear ratios 1, 3, 4, 6, 7, 9 and 10, the transmission can be used as a parallel hybrid transmission.

When the 3 gear ratios 2, 5 and 8 are used, the e-CVT mode is available in each of these gear ratios by controlling the electrical machine in driving mode.

While one of these three gear ratios (2, 5 and 8) is used, if actuator A4′ is in position N, the e-CVT mode is available in each of these gear ratios whatever the state of machine 22, whether in driving or receiving mode.

The pure electrical mode in the short gear ratio is obtained when A3 is in position 1 and A4′ is in a neutral position. In this mode, the vehicle can be run in pure electrical mode in forward and reverse gear.

If A4′ is in position 2, only forward gear is available.

If A3 is in position N, reverse gear and energy recovery in forward gear are no longer accessible.

The pure electrical mode in the long gear ratio is obtained when A3 is in position 2 and actuator A4′ is in position N or 2. In this mode, the vehicle can be run in pure electrical mode in forward gear.

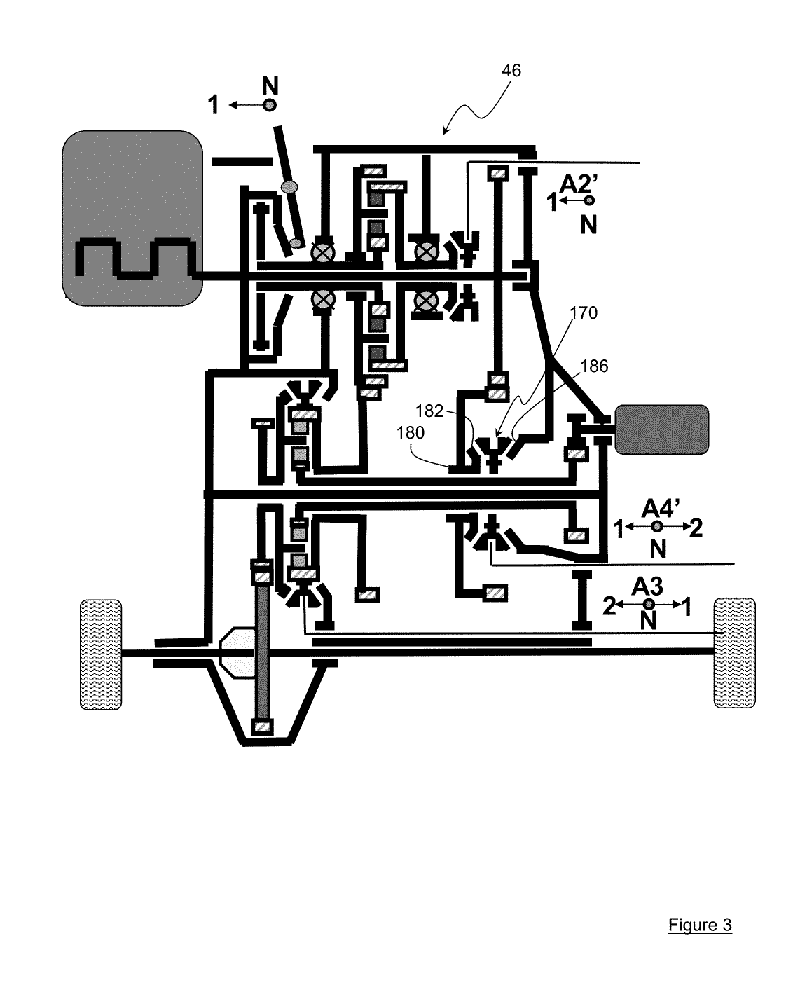

In the variant of FIG. 3, which is very close to that of FIG. 2, tubular sleeve 58 and free wheel 160 of FIGS. 1 and 2 have been removed.

In this variant, fixed part 46 of the powertrain carries a fixed bearing surface 186 opposite synchromesh 170.

The double-acting synchromesh thus cooperates, from a neutral position (position N), either with bearing surface 182 carried by tubular shaft 180 (position 1), or with bearing surface 186 carried by fixed port 46 of the powertrain.

The 10 gear ratios are obtained for the same actuator positions.

When machine 22 is not blocked, that is for the 7 gear ratios 1, 3, 4, 6, 7, 9 and 10, the transmission can be used in parallel hybrid mode.

While one of these three gear ratios (2, 5 and 8) is used, if actuator A4′ is in position N, the e-CVT mode is available in each of these gear ratios whatever the state of machine 22, whether in driving or receiving mode.

The pure electrical mode in the short gear ratio is obtained when A3 is in position 1 and A4′ in neutral position. In this mode, the vehicle can be run in pure electrical mode in forward and reverse gear.

If A4′ is in position 2, electrical traction is not available. This corresponds to a parking brake.

If A3 is in position N, reverse gear and energy recovery in forward gear are no longer accessible.

The pure electrical mode in the long gear ratio is obtained when A3 is in position 2 and actuator A4′ is in position N. In this mode, the vehicle can be run in pure electrical mode in forward gear.

1-12. (canceled)

13. A powertrain for an automotive vehicle comprising:
a thermal engine, a speed variation device including an engine epicyclic gear train with a sun gear and a crown, which are connected to shaft of thermal engine by a controlled coupling and to a fixed part of the vehicle by a one-way coupling, a epicyclic gear train on a machine shaft which is substantially parallel to an engine shaft and connecting engine epicyclic gear train to a track for motion transmission to a drive axle, the machine epicyclic gear train including a sun gear carried by a sun gear shaft, a crown and a planet gear carrier, and a speed variation device comprising an engine toothed wheel carried by engine shaft connecting the engine shaft to a machine toothed wheel carried by the sun gear shaft.

14. A powertrain for an automotive vehicle as claimed in claim 13, wherein:
the engine toothed wheel is mounted to idle on the engine shaft which carries a controlled coupling for connection between the engine shaft and the machine toothed wheel.

15. A powertrain for an automotive vehicle as claimed in claim 14, wherein:
the controlled coupling comprises a disc clutch.

16. A powertrain for an automotive vehicle as claimed in claim 13, wherein:
the engine toothed wheel is fixedly mounted on engine shaft.

17. A powertrain for an automotive vehicle as claimed in claim 13, wherein:
the machine toothed wheel is fixedly mounted on the sun gear shaft.

18. A powertrain for an automotive vehicle as claimed in claim 14, wherein:
the machine toothed wheel is fixedly mounted on the sun gear shaft.

19. A powertrain for an automotive vehicle as claimed in claim 15, wherein:
the machine toothed wheel is fixedly mounted on the sun gear shaft.

20. A powertrain for an automotive vehicle as claimed in claim 16, wherein:
the machine toothed wheel is fixedly mounted on the sun gear shaft.

21. A powertrain for an automotive vehicle as claimed in claim 13, wherein:
the machine toothed wheel is mounted to idle on the sun gear shaft and the gear shaft carries a controlled coupling for connection between the gear shaft and the wheel.

22. A powertrain for an automotive vehicle as claimed in claim 14, wherein:
the machine toothed wheel is mounted to idle on the sun gear shaft and the gear shaft carries a controlled coupling for connection between the gear shaft and the wheel.

23. A powertrain for an automotive vehicle as claimed in claim 15, wherein:
the machine toothed wheel is mounted to idle on the sun gear shaft and the gear shaft carries a controlled coupling for connection between the gear shaft and the wheel.

24. A powertrain for an automotive vehicle as claimed in claim 16, wherein:
the machine toothed wheel is mounted to idle on the sun gear shaft and the gear shaft carries a controlled coupling for connection between the gear shaft and the wheel.

25. A powertrain for an automotive vehicle as claimed in claim 21, wherein:
the controlled coupling cooperates with a bearing surface carried by the machine toothed wheel or with a bearing surface carried by a sleeve mounted to idle on the sun gear shaft.

26. A powertrain for an automotive vehicle as claimed in claim 22, wherein:
the controlled coupling cooperates with a bearing surface carried by the machine toothed wheel or with a bearing surface carried by a sleeve mounted to idle on the sun gear shaft.

27. A powertrain for an automotive vehicle as claimed in claim 23, wherein:
the controlled coupling cooperates with a bearing surface carried by the machine toothed wheel or with a bearing surface carried by a sleeve mounted to idle on the sun gear shaft.

28. A powertrain for an automotive vehicle as claimed in claim 24, wherein:
the controlled coupling cooperates with a bearing surface carried by the machine toothed wheel or with a bearing surface carried by a sleeve mounted to idle on the sun gear shaft.

29. A powertrain for an automotive vehicle as claimed in claim 25, wherein:
the sleeve is carried by a fixed part of the powertrain extending through a one-way coupling.

30. A powertrain for an automotive vehicle as claimed in claim 26, wherein:
the sleeve is carried by a fixed part of the powertrain extending through a one-way coupling.

31. A powertrain for an automotive vehicle as claimed in claim 27, wherein:
the sleeve is carried by a fixed part of the powertrain extending through a one-way coupling.

32. A powertrain for an automotive vehicle as claimed in claim 28, wherein:
the sleeve is carried by a fixed part of the powertrain extending through a one-way coupling.

33. A powertrain for an automotive vehicle as claimed in claim 25, wherein:
the sleeve is carried by a fixed part of the powertrain extending through a one-way coupling.

34. A powertrain for an automotive vehicle as claimed in claim 29, wherein:
the sun gear shaft carries a controlled coupling for connection with sleeve.

35. A powertrain for an automotive vehicle as claimed in claim 21, wherein:
the controlled coupling is coupled with a bearing surface carried by the machine toothed wheel or with a bearing surface carried by a fixed part of the powertrain.

36. A powertrain for an automotive vehicle as claimed in claim 13, comprising:
a generator for imparting at least motion to the vehicle.

37. A powertrain for an automotive vehicle as claimed in claim 25, wherein:
a rotor of a machine is connected to the sun gear shaft.
